(19) United States
(12) Patent Application Publication
(10) Pub. No.: US 2011/0038145 A1
(43) Pub. Date: Feb. 17, 2011

(54) LED Fixture with Passive Cooling

(75) Inventors: John M. Davenport, Middleburg Heights, OH (US); Joseph G. Kaveski, Leawood, KS (US); Jeremias A. Martins, Twinsburg, OH (US)

Correspondence Address: BRUZGA & ASSOCIATES, 11 BROADWAY, SUITE 715, NEW YORK, NY, 10004, US

(73) Assignee: Energy Focus, Inc., Solon, OH (US)

(21) Appl. No.: 12/854,713

(22) Filed: Aug. 11, 2010

Related U.S. Application Data
(60) Provisional application No. 61/233,029, filed on Aug. 11, 2009.

(51) Int. Cl. F21V 29/00

(52) U.S. Cl. 362/218

(57) ABSTRACT

Disclosed is an LED fixture with passive cooling. The fixture includes a plurality of elongated tubes, each containing an array of LEDs mounted on a respective first surface or surfaces of one or more circuit boards. A frame mounts to a building structure and holds the ends of the tubes. Each tube is sufficiently spaced from any adjacent tube and from any other structure of the frame, and the frame is sufficiently open at the top and bottom, whereby heat from the tubes is capable of being dissipated merely by passive thermal transfer into an air flow created by the heat of the tubes, which air flow moves from beneath the tubes to above the tubes.

### FIELD OF THE INVENTION

The present invention relates an LED fixture with a passive cooling arrangement for the LEDs.

### BACKGROUND OF THE INVENTION

So-called “high-bay” lighting is used extensively for illuminating warehouses and other large commercial spaces. In many cases, this is done using fluorescent tubes. However, longer-life alternatives to fluorescent tubes would significantly reduce warehouse costs and the complexity of replacing failed tubes. Development of longer life and higher brightness LEDs has resulted in LED tubes with long life and with a consequent reduced frequency of replacing failed tubes. High-bay lighting requires high output lighting, which can be achieved with LEDs by either using many lower powered LEDs in arrays or fewer higher powered LEDs to provide the desired lighting effect.

LED tubes are often designed to replace fluorescent lamp tubes. Within the elongated, tubular form factor of a fluorescent lamp tube, LED tubes may utilize an array of LEDs of sufficient lumen output to have a similar lighting capacity as that of fluorescent lamps being replaced. LEDs are available in higher power (e.g., 5 watts) and lower power (e.g., ¼ watt) configurations. Fewer higher power LEDs would be needed to achieve a similar lighting capacity as a fluorescent lamp being replaced, compared with lower power LEDs. However, to keep LED junction temperature below a predetermined limit, which is necessary to ensure long life with adequate light output, high power LEDs have a greater need for removal of heat than lower power LEDs. Higher power LEDs thus typically require some form of advanced heat-sinking capability, typically in the form of complete, engineered thermal paths from LED to exterior ambient. Such engineered thermal paths often require the use of large metal masses that act as heat sinks to facilitate radiation of heat into the ambient.

Two main approaches to using LED tubes for commercial high-bay or other applications are: (1) to use lower power LEDs in LED tubes that are mounted in conventional fluorescent lamp fixtures, or (2) to use higher power LEDs in specially designed illumination fixtures having complete, engineered thermal-dissipation paths from LED to exterior ambient and larger metal masses that act as heat sinks. A drawback of the first approach is that LED tubes used in conventional fluorescent lamp fixtures lack an efficient way to dissipate heat, since such fixtures typically use a reflector above and along the elongated sides of the tubes, which is necessary when using fluorescent lamps for directing light downwardly. Typical fluorescent lamp fixtures are also closed at the longitudinal ends of the tubes and sometimes are even closed at the bottom by a light diffuser. Because heat from LED tubes cannot easily exit from such fluorescent lamp fixtures, the LED tubes run hotter, so that the first approach reduces the lifetime of the LED tubes. The second approach, using higher power LEDs, suffers from the extra cost of using an LED fixture with engineered thermal-dissipating paths and larger metal masses as described above.

It would be desirable to provide an LED fixture that can accommodate both lower power and higher power LEDs, without the requirement for a complete engineered thermal-dissipation path from LED to ambient, and while preserving a high lifetime of the LEDs.

### BRIEF SUMMARY OF THE INVENTION

In one form, the present invention provides an LED fixture with passive cooling. The fixture includes a plurality of elongated tubes, each containing an array of LEDs mounted on a respective first surface or surfaces of one or more circuit boards. A frame mounts to a building structure and holds the ends of the tubes. Each tube is sufficiently spaced from any adjacent tube and from any other structure of the frame, and the frame is sufficiently open at the top and bottom, whereby heat from the tubes is capable of being dissipated merely by passive thermal transfer into an air flow created by the heat of the tubes, which air flow moves from beneath the tubes to above the tubes.

The foregoing LED fixture, which may be that sold under trade name Power Frame™ for LED fixtures, beneficially can accommodate both lower power and higher power LEDs, without the requirement for a complete engineered thermal-dissipation path from LED to ambient, and while preserving a high lifetime of the LEDs.

### BRIEF DESCRIPTION OF THE DRAWINGS

In the following drawings, like reference numbers refer to like parts:

FIG. 1 is a top view of an LED fixture in accordance with the invention.

FIG. 2 is a bottom view of the LED fixture of FIG. 1.

FIG. 3 is a detail view of that portion of the LED fixture of FIG. 2 contained in the circle marked 3 in FIG. 2.

FIG. 4 is a perspective view of an LED tube and tube socket.

FIG. 5. is a cross-sectional view, taken at arrows 5, 5 in FIG. 1.

FIG. 6 is a cross-sectional view, taken at arrows 6, 6 in FIG. 1.

FIG. 7 is a cross-sectional view, taken at arrows 7, 7 in FIG. 1.

FIG. 8 is a cross-sectional view of an alternate embodiment of the LED tube.

FIG. 9 is a schematic describing passive air flow for withdrawing heat from the LED tubes, taken at arrows 9, 9 in FIG. 1.

FIG. 10 is similar to FIG. 9 except that it shows LED tubes mounted in a conventional fluorescent fixture.

### DETAILED DESCRIPTION OF THE PREFERRED EMBODIMENT

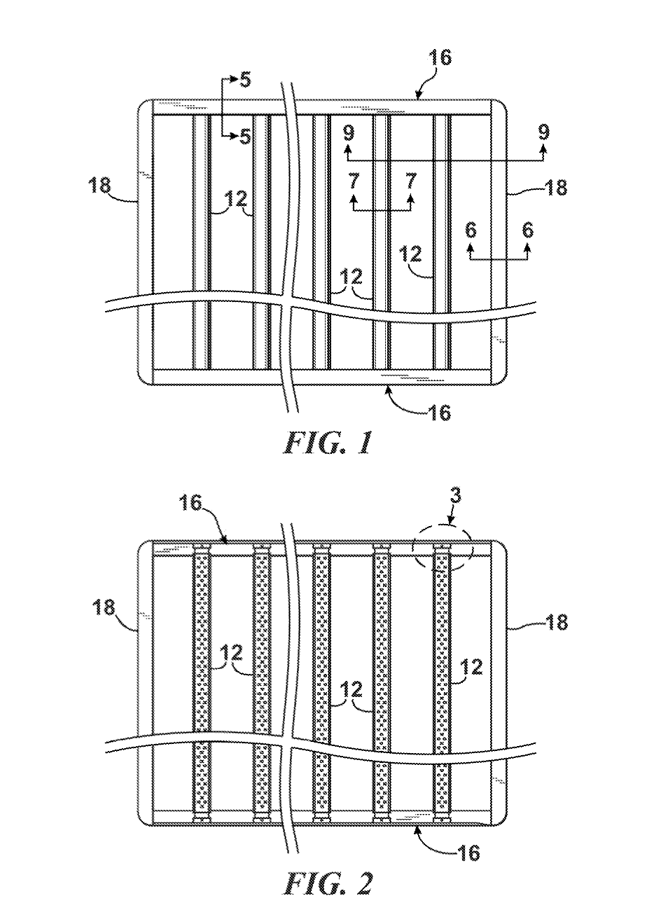

FIGS. 1 and 2 show an LED fixture 10 in accordance with the invention. Fixture 10 includes a plurality of enclosed LED tubes 12, which may typically number from two to twelve, and vary in length from 2 feet (61 cm) to 8 feet (2.4 meters). Each tube 12 may be located at a distance from another parallel tube 12 of from one cm to one meter, and from the side member 18 at a distance of one cm to one meter. The ends of LED tubes 12 are held by frame end members 16. Frame side members 18 may be welded or otherwise joined to frame end members 16 to hold end members 16 in place. The same frame may accommodate twelve LED tubes 12, or a lesser number of tubes. With a lesser number of LED tubes in the same frame, the tubes may be spaced further apart from each other than in the case where twelve tubes are accommodated in the same frame.

The term “LED tube” as used herein is meant to include tubes with circular cross-sections along their length (i.e., cylindrical tubes) as well as tubes that do not have a circular cross section along their length. Typically, the ratio of maximum cross sectional dimension to minimum cross sectional dimension will be less than about 2 to 1 for all “LED tubes.”

In the preferred embodiment, frame end members 16 and frame side members 18 may be made from any of a number of materials, including metal or plastic, because they exist merely for structural purposes, not heat conduction. The specific construction described herein for the frame end members 16 and frame side members 18 is merely exemplary, and many other constructions will be routine to those of ordinary skill in the art based on the present specification.

As will be further described below, cooling of the LED tubes 12 is achieved by the spacing between LED tubes 12 and the lack of significant air-blocking structures above and below the LED tubes. Beneficially, the lumen output from the fixture 10 can be increased or decreased by simply configuring the fixture to accommodate a lesser or greater number of LED tubes 12. A fixture 10 may typically have twelve or fewer or more LED tubes 12.

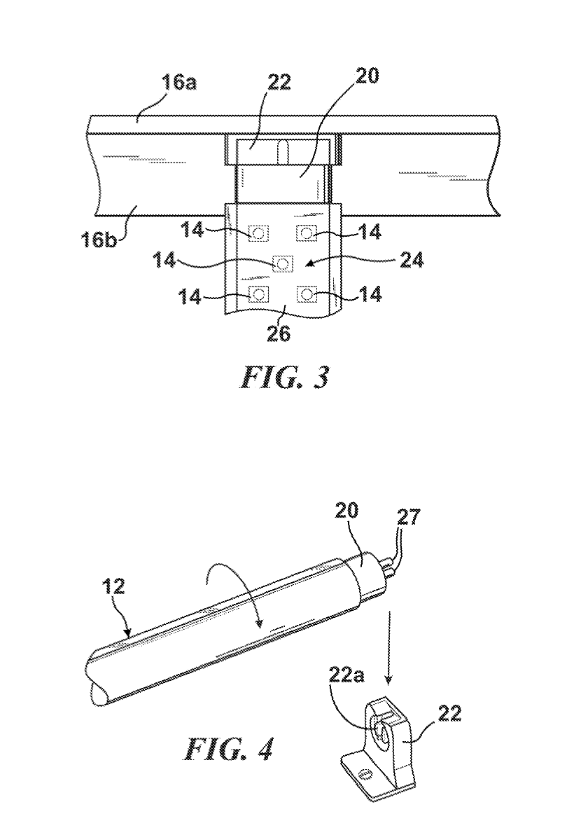

FIG. 3 shows an LED tube 12 with a metal LED tube endcap 20 mounted to LED tube receptacle 22, which abuts a vertical section 16a of frame end member 16 and is mounted to horizontally-extending flange 16b of end member 16. Flange 16b depends from vertical section 16a. One or more circuit boards 26 of dielectric insulating material are affixed inside of each LED tube 12. An array of LEDs 14 is mounted on one side of the one or more circuit boards 26.

LED tube receptacle 22 provides both an electrical connection to the frame and a structural mechanism by which the LED tube 12, once inserted, is held securely overhead. Receptacle 22 may be a standard receptacle used for fluorescent lamps, so that FIG. 4 portrays the insertion of an LED tube 12 into LED tube receptacle 22 in the same way that a fluorescent tube (not shown) is inserted into a corresponding receptacle. Thus, electrodes 27 of LED tube 12, oriented vertically one above the other, are inserted in the direction shown into slots 22a of tube receptacle 22, and the tube is rotated 90 degrees as shown by the rounded arrow in FIG. 4 so that the electrodes are snap fit (or locked) into place in contact with internal electrodes (not shown) of the receptacle 22. The internal electrodes of the receptacles 22 are supplied with electrical power in a customary manner. Other ways of providing electrical power to the LEDs 14 in LED tubes 12 will be apparent to the person of ordinary skill in the art.

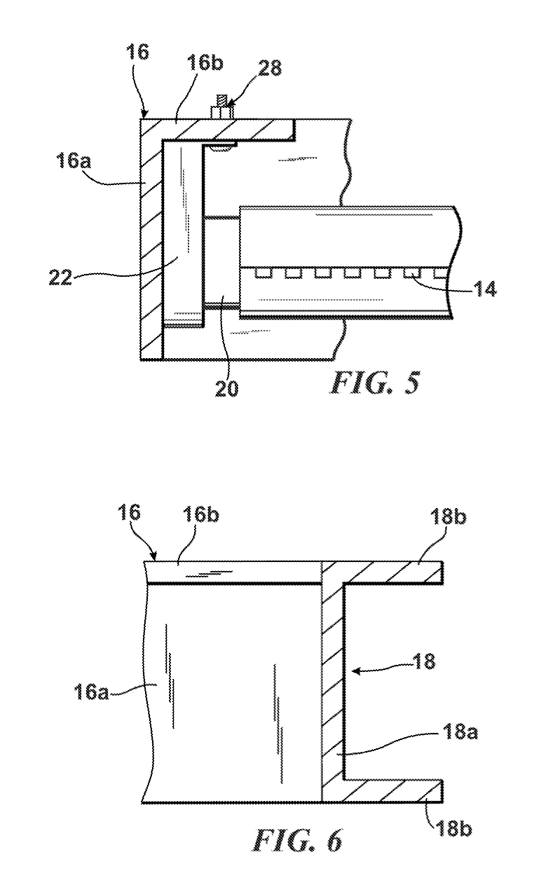

FIG. 5 shows an LED tube 12 connected to tube receptacle 22. Tube receptacle 22 may be fixed to flange 16b by a screw and bolt 28. Alternate embodiments of may utilize other configurations and shapes of end members 16, such as those with C-shaped or I-beam cross-sections.

LEDs 14 on circuit board 26 (FIG. 3) provide light in the direction of orientation of the LEDs, which would usually be downwards for a ceiling-mounted LED fixture.

FIG. 6 shows a frame side member 18, which, in one embodiment, consists of a vertical section 16a and two horizontal flanges 18b depending from the vertical section 16a. This configuration is merely exemplary. Other embodiments can have frame side members 18 that have I-beam, rectangular, or cylindrical cross-sections, by way of example. Such structural variations would typically have little to no effect on heat dissipation from LED tubes 12, since there would be a typical minimum spacing of approximately from one cm to one meter between the side member 18 and the nearest LED tube 12 to allow the desired level of convective airflow, as further described below.

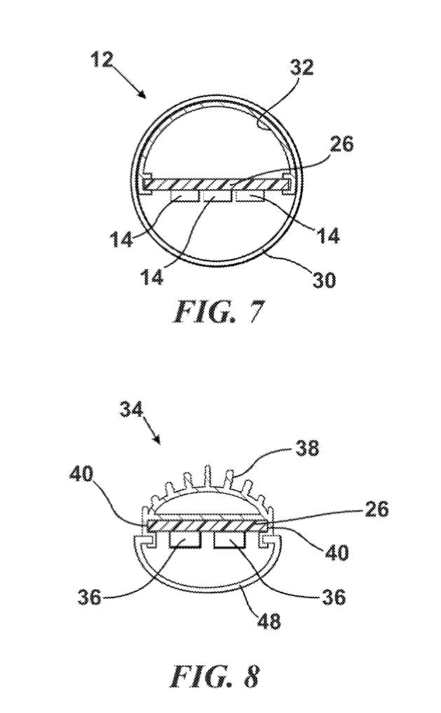

FIG. 7 shows one variety of an LED tube 12 that may be used in the inventive LED fixtures. As shown, LED tube 12 has an envelope 30, typically of acrylic, and contains circuit board 26 that is held in position by a mounting bracket 32 with a generally hemispherical cross-section. Mounting bracket 32 may be metallic. LEDs 14 are mounted on one face of circuit board 26, facing away from the mounting bracket. Envelope 30 encloses mounting bracket and circuit board 26 and seals circuit board 26 from dust, or other environmental contaminants. The LED tube 12 of FIG. 7 may typically be of a lower power variety, wherein each LED consumes about ¼ watt of electrical power, for instance.

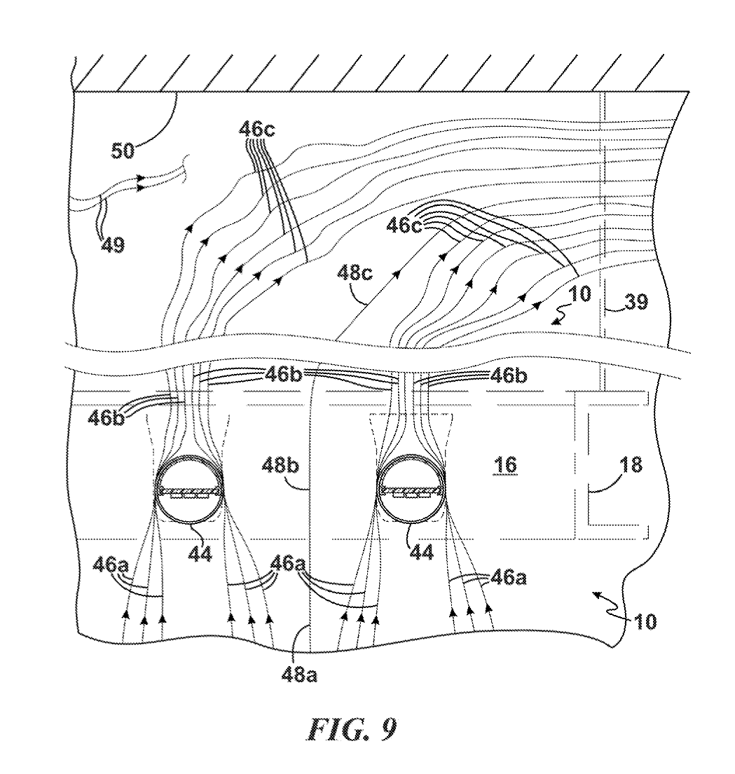

A wide variety of LED tubes may be inserted into the fixture 10 of FIGS. 1 and 2. FIG. 8 shows just one alternative LED tube 34. LED tube 34 has LEDs 36 of higher power than LEDs 14 of FIG. 7. For instance, LEDs 36 may consume more than about one watt and typically up to at least about 5 watts of electrical power. Such higher power LEDs 36 may require a multi-finned heat sink 38 for removing heat away from LEDs 36. Multi-finned heat sink 38 is mounted on circuit board 26, directly opposite from LEDs 36, so as to be able to rapidly remove heat from the LEDs 36. Circuit board 26 of LEDs 36 in FIG. 8 is held by a mounting bracket portion 40 of heat sink 38, and has an envelope 42 for sealing circuit board 26 from dust and other environmental contaminants.

As will be appreciated from the foregoing description, fixture 10 of FIGS. 1 and 2 has what may be called an “open” architecture. This can be seen from reviewing the LED fixture 10 of FIGS. 1-2 and the sectional views of frame end members 16 and frame side members 18 in FIGS. 3 and 5-6. Such an open architecture provides the capability of passively dissipating heat from the LED tubes 12 (e.g., FIGS. 1 and 7) or 34 (FIG. 8) into an air flow created by the heat of the LED tubes.

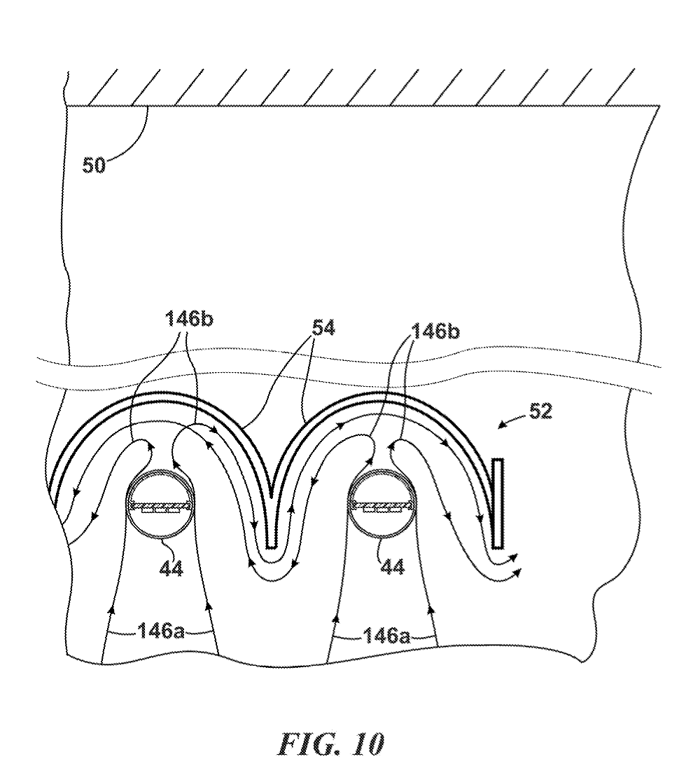

FIG. 9 shows an approximation of passive air flow cooling of LED tubes 44, which may either LED tubes 30 or 42 of FIG. 7 or 8, respectively, by way of example LED tubes 44 are contained in a fixture 10 having end frame members 16 and side frame members 18. Either of frame members 16 or 18 may include, as part of the “frame” as that term is used herein, building- (e.g., ceiling-) mounted supports such as support 39, which may be metal wires, by way of example. Heat from the LED tube tubes 44 creates an upward flow of air 46a, 46b and 46c. As air flow 46a is drawn upwardly to the vicinity of respective LED tubes 44, the air becomes heated by convection and usually by some radiation and rises upwardly as heated air 46b. Typically, a ceiling 50 or other structure limits further upward flow of air. Since fixture 10 will typically have more than about four LED tubes 44, and since the illustrated tubes 44 are close to the right-hand shown end of the fixture 10, the air flow will normally turn to the right as shown at 46c. On the other hand, air flow 48a, 48b and 48c does not pass as close to tubes 44 as does air flow 46a and 46b, and thus becomes relatively less heated than air flow 46a and 46b. Air flow 49, only partially shown, would come from LED tubes 44 (not shown) located to the left of the illustrated LED tubes 44.

By way of contrast, FIG. 10 shows relatively obstructed thermal paths for LED tubes 44 when mounted in a conventional fluorescent lamp fixture 52. Some airflow 146a and 146b may occur, but it is less robust than corresponding airflow 46a and 46b in FIG. 9. This is due to restrictions imposed on air flow by reflectors 54 of fluorescent lamp fixture 52, and other restrictions as mentioned earlier in this specification. For each LED tube 44 shown, one airflow line 146b is shown meandering to the left, and one airflow line 146b is shown meandering to the right. The greater number of airflow lines 46b in earlier FIG. 9 indicates that, in FIG. 10, the airflow beneath the reflectors 54 is relatively stagnant and does not effectively cool the LED tubes 44.

Regarding the mentioned “open” architecture of fixture 10 of FIGS. 1 and 2, it is preferable that the frame members 16 and 18 be so constructed as to prevent blockage of air flow 46a-46c (FIG. 9) by more than five percent in terms of cooling capacity compared to frame members that lacks any structure above or below the LED tubes (e.g., 44, FIG. 9).

It is also preferable that no part of the LED fixture (e.g., 10, FIGS. 1 and 2), except for any mounting support (.e.g., 39, FIG. 9) for the fixture, overlies or underlies the area bounded by the LEDs tubes (e.g., 44, FIG. 9) that are most spaced apart from each other and bounded by the ends of the tubes.

It is further preferable that no part of the LED fixture (e.g., 10, FIGS. 1 and 2), except for any mounting support (e.g., 39, FIG. 9) for the fixture, overlies or underlies the LED tubes (e.g., 44, FIG. 9).

Further, it is preferably that each tube (e.g., 44, FIG. 9) is sufficiently spaced from any adjacent tube and from any other structure of the frame (e.g., 16, 18, FIGS. 1 and 2), and that the frame is sufficiently open at the top and bottom to achieve the following objective: Allowing heat from the tubes to be capable of being dissipated merely by passive thermal transfer into an air flow (e.g., 46a-46c, FIG. 9) created by the heat of the tubes, which air flow moves from beneath the tubes to above the tubes.

Of course, an inventive LED fixture could be installed in a location in which an actively induced air flow exists apart from that caused by heat from the tubes 44 in FIG. 9. Such an actively induced pre-existing air flow or subsequently created air flow may be from a fan or other mechanism for cooling the air in the vicinity of the fixture. However, inventive advantages are still realized by the simplicity of the fixture and the ease in deploying the fixture without needing to consider any actively induced pre-existing or subsequently created air flow existing apart from that caused by heat from the tubes 44 in FIG. 9. Moreover, use of LED tubes in an open-architecture frame as described above will result in lower LED junction temperature than use of such LED tubes in a conventional fluorescent lamp fixture that lacks the noted open architecture. Such lower LED junction temperature results in longer LED life.

It is preferable for the LED fixture of the invention to be designed so that the heat from the tubes, which is capable for being dissipated merely by thermal transfer into air flow 46a-46c of FIG. 9, is adequate to maintain the lifetime of the LEDs to an average of 40,000 hours at a level which varies from a rated lumen output level for an LED fixture installed in a building to an output level that is at least about 70 percent of such rated output level. By “rated output level” is meant herein a level determined by the specific nature of the installed environment and the current and voltage of power applied to the LEDs.

The open architecture frame for LED tubes described above provides an LED fixture that can accommodate both lower power and higher power LEDs, without the requirement for complete engineered thermal-dissipation paths from LED to ambient, and while preserving a high lifetime of the LEDs.

While the invention has been described with respect to specific embodiments by way of illustration, many modifications and changes will occur to those skilled in the art. It is, therefore, to be understood that the appended claims are intended to cover all such modifications and changes as fall within the true scope and spirit of the invention.

What is claimed is:

1. An LED fixture with passive cooling, comprising:
a) a plurality of elongated tubes, each containing an array of LEDs mounted on a respective first surface or surfaces of one or more circuit boards; and
b) a frame for mounting to a building structure and for holding the ends of the tubes; and
c) each tube being sufficiently spaced from any adjacent tube and from any other structure of the frame, and the frame being sufficiently open at the top and bottom, whereby heat from the tubes is capable of being dissipated merely by passive thermal transfer into an air flow created by the heat of the tubes, which air flow moves from beneath the tubes to above the tubes.

2. The LED fixture of claim 1, wherein the frame is so constructed as to prevent blockage of said air flow by more than five percent in terms of cooling capacity compared to a frame that lacks any structure above or below the LED tubes.

3. The LED fixture of claim 1, wherein no part of the fixture, except for any mounting support for said fixture, overlies or underlies the area bounded by the LEDs tubes that are most spaced apart from each other and bounded by the ends of the tubes.

4. The LED fixture of claim 1, wherein no part of the fixture, except for any mounting support for said fixture, overlies or underlies LED tubes.

5. The LED fixture of claim 1, wherein said one or more circuit boards are free of multi-finned heat sinks respectively mounted directly opposite one or more of said LEDs on a respective second major surface or surfaces of said circuit board facing in an opposite direction from said first major surface.

6. The LED fixture of claim 1, wherein said one or more circuit boards have a respective multi-finned heat sink or heat sinks respectively mounted directly opposite one or more of said LEDs on a respective second major surface or surfaces of said circuit board facing in an opposite direction from said first major surface.

7. The LED fixture of claim 1, wherein the heat from the tubes, which is capable for being dissipated merely by thermal transfer into said air flow, is adequate to maintain the lifetime of the LEDs to an average of 40,000 hours at a level which varies from a rated lumen output level for an LED fixture installed in a building to an output level that is at least about 70 percent of such rated output level.
